(19) United States
(12) Patent Application Publication
(10) Pub. No.: US 2004/0217318 A1
(43) Pub. Date: Nov. 4, 2004

(54) Gastight disc slide

(76) Inventor: Alexander Hayduk, Gammelsdorf (DE)

Correspondence Address: WILLIAM COLLARD, COLLARD & ROE, P.C., 1077 NORTHERN BOULEVARD, ROSLYN, NY, 11576, US

(21) Appl. No.: 10/786,998

(22) Filed: Feb. 25, 2004

(30) Foreign Application Priority Data
Apr. 29, 2003 (DE) 103 19 302.2

(51) Int. Cl. F16K 3/00

(52) U.S. Cl. 251/326

(57) ABSTRACT

A disc slide conveys pure granules or dusts, and can be mounted between a feed pipeline and a discharge pipeline. The disc slide comprises a casing which includes a valve seat comprising two sealing discs and a shut-off element, which is held movably therein and is in the form of a slide plate, and an actuation element for the slide plate. The valve seat and the slide plate are provided with a surface made from silicon or quartz glass or consist of these materials.

### BACKGROUND OF THE INVENTION

1. Field of the Invention

The invention relates to a gastight disc slide.

2. The Prior Art

The handling of granular polysilicon which has been deposited in a fluidized bed and has grain sizes of approximately 200 μm to 3 mm requires shut-off fittings to control the flow of granules. Pipelines that are lined with materials that prevent contamination of the silicon, such as quartz glass, silicon or ceramic, are used to discharge the polysilicon granules from the fluidized-bed reactor. The flow of granules in vertical conveying sections is shut off using fittings which are likewise lined with the abovementioned materials. An example of a fitting of this type is described in U.S. Pat. No. 5,205,998. These shut-off fittings are not generally sufficiently gastight, and consequently it is necessary to use combinations of the abovementioned shut-off fittings and downstream gastight fittings.

U.S. Pat. No. 6,412,756 has disclosed a gastight ball valve for granules having a specially shaped shut-off ball. However, a drawback of this is the complex process of producing the shut-off ball and the tendency of the fitting to become blocked when it is exposed to granule grain sizes which are not in spec.

German Patent No. DE 3829506 C2 has disclosed a shut-off valve in which the adjustable valve element and the valve seat element consist of engineering ceramic, the engineering ceramic materials being selected in such a way that they are paired to reduce sticking. FIGS. 2 and 3 illustrate a disc slide as an example of a shut-off valve of this type. Disc slides are used in-a very wide range of sectors, primarily for handling abrasive and corrosive media. Disc slides are distinguished by the fact that there is not usually a seal coming into contact with the medium, since the sealing action is brought about by the discs, which have been ground together, bearing completely flat against one another.

### SUMMARY OF THE INVENTION

It is an object of the present invention to simplify the conveying of granular materials, such as granular polysilicon deposited in a fluidized bed or other pure or high-purity granules and dusts and to provide a shut-off fitting which is able to interrupt a flow of granules and ensure a gastight seal between a feed pipeline and a discharge pipeline. Moreover, the shut-off fitting should be simple to produce in any desired size.

The object is achieved by a disc slide according to the invention which can be mounted between a feed pipeline and a discharge pipeline, comprising a casing which includes a valve seat, comprising two sealing discs, and a shut-off element, which is held movably therein and is in the form of a slide plate, and an actuation element for the slide plate wherein the valve seat and the slide plate are provided with a surface made from silicon or quartz glass or consist of these materials.

In view of the teaching of German Patent No. DE 3829506 C2, which specifically indicates that the problem of disruptive sticking of the valve element and valve seat element when ceramic materials are used can only be solved by pairing different ceramic materials, the person skilled in the art will not consider using a disc slide as a shut-off fitting for controlling a flow of polysilicon granules, since a combination of materials of this type would inevitably contaminate the silicon granules.

Surprisingly, however, corresponding tests have shown that a disc slide whose valve seat and shut-off element are provided with a surface made from silicon or quartz glass or are made from these materials does not have any problems in terms of sticking between the shut-off element and valve seat. The invention therefore also relates to the use of a disc slide according to the invention for handling a granular polysilicon which has been deposited in a fluidized bed or other pure or high-purity granules and dusts.

The surfaces of the shut-off element and valve seat in the disc slide according to the invention may be identical or different. They are preferably made from the same material in both cases. The material is particularly preferably silicon.

It is preferable for all the surfaces of the disc slide which come into contact with the flow of material to be made from silicon or quartz glass. It is particularly preferable for the shut-off element to consist of silicon or quartz glass. The silicon may be in single-crystal or polycrystalline form. Polycrystalline silicon is preferred for cost reasons.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

FIG. 1 shows the basic structure of a disc slide according to the invention, in which all the surfaces of the disc slide which come into contact with granules and dusts consist of silicon or quartz glass.

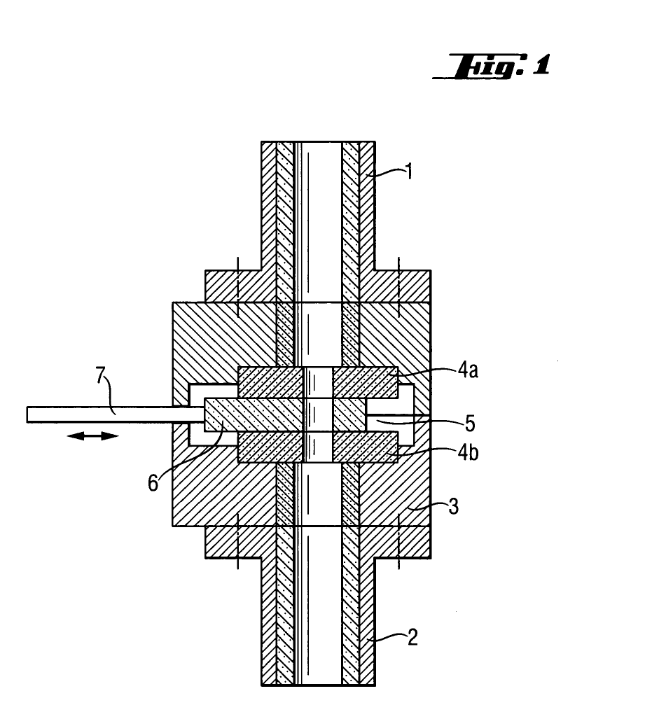

### DETAILED DESCRIPTION OF THE PREFERRED EMBODIMENT

Referring now in detail to the drawing, the drawing shows a disc slide mounted between a feed pipeline (1) and a discharge pipeline (2), comprising a casing (3) which includes a valve seat (5), comprising two sealing discs (4a, 4b), and a shut-off element, which is held movably therein and is in the form of a slide plate (6), and an actuation element (7) for the slide plate (6), wherein the valve seat (5) and the slide plate (6) are provided with a surface made from silicon or quartz glass or consist of these materials.

Accordingly, while only a single embodiment of the present invention has been shown and described, it is obvious that many changes and modifications may be made thereunto without departing from the spirit and scope of the invention.

What is claimed is:

1. A disc slide for conveying pure granules or dusts, which can be mounted between a feed pipeline and a discharge pipeline, comprising:
a casing;
a valve seat mounted in the casing and comprising two sealing discs;
a shut-off element in the form of a slide plate movably held between the sealing discs; and
an actuation element for the slide plate;
wherein the valve seat-and the slide plate are provided with a surface made from silicon or quartz glass or consist of these materials.

2. The disc slide as claimed in claim 1, wherein all surfaces of the disc slide which come into contact with granules and dusts consist of silicon or quartz glass.

3. The disc slide as claimed in claim 1, wherein the valve seat and the slide plate consist of silicon.
